(19) United States
(12) Patent Application Publication
(10) Pub. No.: US 2009/0114737 A1
(43) Pub. Date: May 7, 2009

(54) Aerosolization device

(75) Inventors: Shan-Yi Yu, Taipei County (TW); Han-Chang Liu, Taipei County (TW); Wen-Yu Tsai, Taipei County (TW)

Correspondence Address: BACON & THOMAS, PLLC, 625 SLATERS LANE, FOURTH FLOOR, ALEXANDRIA, VA, 22314-1176, US

(73) Assignee: HEALTH & LIFE CO., LTD., CHUNG HO CITY, (TW)

(21) Appl. No.: 11/979,665

(22) Filed: Nov. 7, 2007

(51) Int. Cl. B05B 3/16

(52) U.S. Cl. 239/69; 239/102.2

(57) ABSTRACT

In an aerosolization device, an aerosol generator is installed a position proximate to an opening at the bottom of a liquid container for aerosolizing a supplied liquid in the container and a sensor is provided to detect a variation of electric characteristic according to a condition whether or not the liquid in the container is in contact with the aerosol generator and the variation of electric characteristic is sent to a controller for computation, so as to control whether to continue operating or stop operating the aerosol generator. If the aerosol generator is controlled to stop its operation, the controller will drive an alarm device to send out an alarm signal at the same time.

### BACKGROUND OF THE INVENTION

1. Field of the Invention

The present invention relates to an aerosolization device, and more particularly to an aerosol medication applying device for steadily supplying a fixed quantity of aerosol medication.

2. Description of the Related Art

In general, a prior art aerosolization device comprises a thin aperture plate coupled to a piezoelectric element for providing an AC voltage to the piezoelectric element to generate a vibration with a fixed frequency, so as to drive the thin aperture plate to vibrate. Like a fluid supplier of a lampwick that sends an aerosol liquid from a storage tank to a surface of the thin aperture plate, so that the liquid is in contact with an aperture area of a thin plate. The liquid is squeezed from the aperture to produce an aerosolization and sprayed out from another side of the thin plate by tapping the liquid in contact with the aperture area.

The aerosolization device is used extensively in different fields such as the liquid aerosolization of perfumes, air fresheners or medication, particularly a medication applying device for applying an aerosol medication. A patient with diseases of respiration can use this aerosolization device to aerosolize a medication and sucks the aerosol medication from a suction opening of the aerosolization device into the patient's bronchus and lung for a treatment or mitigation.

In general, a medical aerosolization device is required to steadily and uniformly supply a fixed quantity of aerosol medication per unit time in order to assure treatment effectiveness. However, most of the present aerosolization devices consume much electric power, and the supply of liquid medication may be interrupted or exhausted without being observed easily. They are not only causing unnecessary power consumption, but also seriously affect the expected effect of a patient's medical treatment. At present, there is no prior art aerosolization device that can provide an effective solution.

### SUMMARY OF THE INVENTION

It is a primary objective of the present invention to provide an aerosolization device that uses a sensor to monitor whether or not a liquid in a container is in contact with an aerosol generator at anytime. If the supply of the liquid is interrupted or exhausted, the controller will control the aerosol generator to stop its operation immediately, so as to assure the normal operation of the aerosolization device to uniformly and steadily provide a fixed quantity of aerosol medication to patients.

A secondary objective of the present invention is to provide an aerosolization device, such that when a controller stops the operation of the aerosol generator, the controller will start an alarm device to send out an alarm signal at the same time to notice a patient to stop using the aerosolization device or refill the medication, so as to normally supply liquid medication to the aerosol generator.

To achieve the foregoing objectives, the aerosolization device comprises: a container to contain a liquid; an aerosol generator installed at a position proximate to an opening at the bottom of the liquid container and interconnected with the container to aerosolize a liquid supplied in the container; a sensor to detect an electric characteristic and the electric characteristic variation according to a condition whether or not the liquid in the container is in contact with the aerosol generator; and a controller to compute the electric characteristic according to the variation of the electric characteristic detected by the sensor and comparing with a predetermined safe range, so as to control the operation or stop the operation of the aerosol generator.

The present invention further comprises an alarm device, such that if the variation of the electric characteristic exceeds the predetermined safe range, the controller will control the operation of the alarm device immediately to send out an alarm signal such as a light signal or a sound signal.

The above and other objects, features and advantages of the present invention will become apparent from the following detailed description taken with the accompanying drawing.

### BRIEF DESCRIPTION OF THE DRAWINGS

FIG. 1 is a perspective view of an aerosolization device of the present invention;

FIG. 2 is an enlarged section view of the aerosolization device;

FIG. 3 is an enlarged view of Section A of FIG. 2;

FIG. 4 is a schematic view of an internal structure of the aerosolization device;

FIG. 5 is a flow chart of controlling the aerosolization device; and

FIG. 6 is an enlarged section view of an aperture plate in the aerosolization device.

### DETAILED DESCRIPTION OF THE PREFERRED EMBODIMENTS

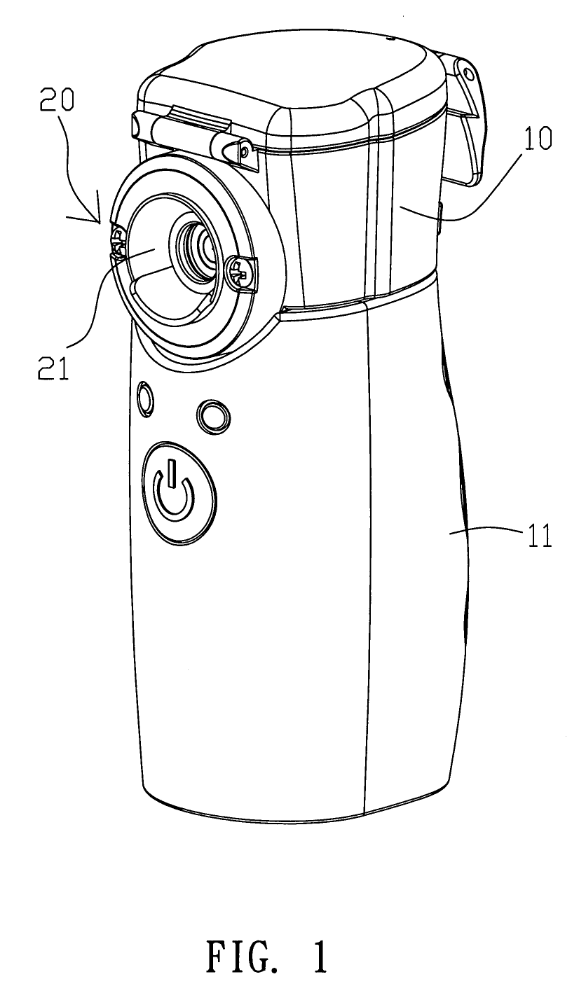

Refer to FIGS. 1 to 4, an aerosolization device of the invention comprises: a container 10 for containing a liquid; an aerosol generator 20 installed at a position proximate to an opening at the bottom of the liquid container 10, and interconnected with the container 10, for aerosolizing the liquid supplied in the container 10; a sensor 30 for detecting an electric characteristic, and the electric characteristic variation according to a condition whether or not the liquid in the container 10 being in contact with the aerosol generator; and a controller 40 for controlling to operate or stop operating the aerosol generator 20 according to the variation of the electric characteristic detected by the sensor 30. In other words, the sensor 30 detects and monitors whether or not the liquid in the container 10 is in contact with the aerosol generator 20 at anytime. If the supply of the liquid is interrupted or exhausted, the controller 40 will control the aerosol generator 20 to stop its operation, so as to assure the aerosolization device could steadily supply a fixed quantity of aerosol medication to the patient in normal operation.

In FIG. 1, the container 10 includes a handle 11 disposed at the bottom of the container 10, and provided for a patient to hold the aerosolization device.

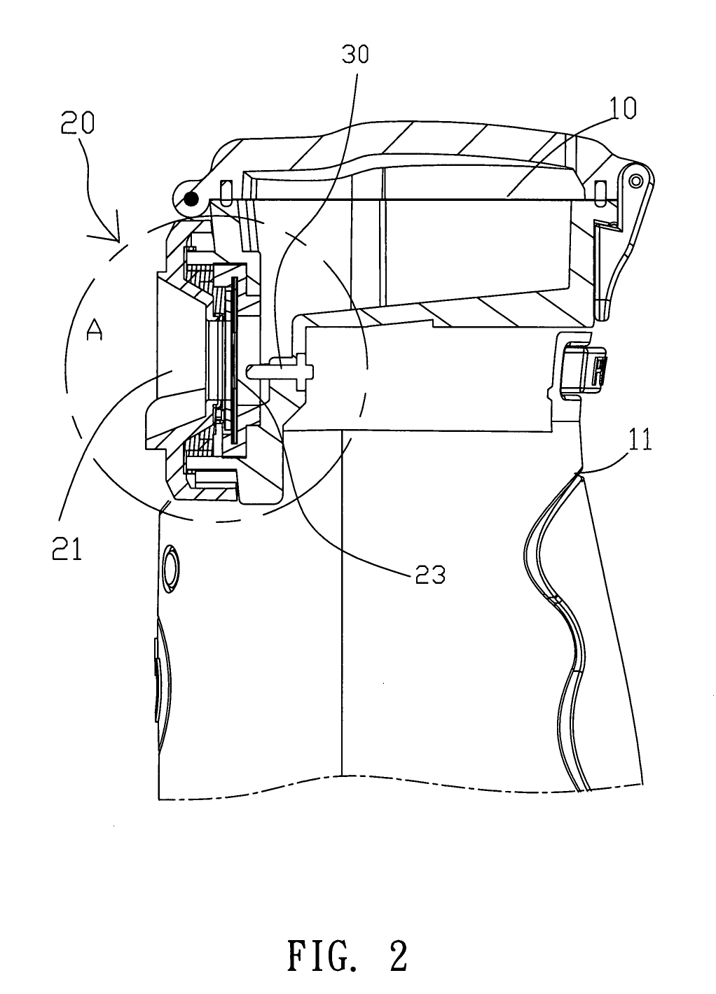

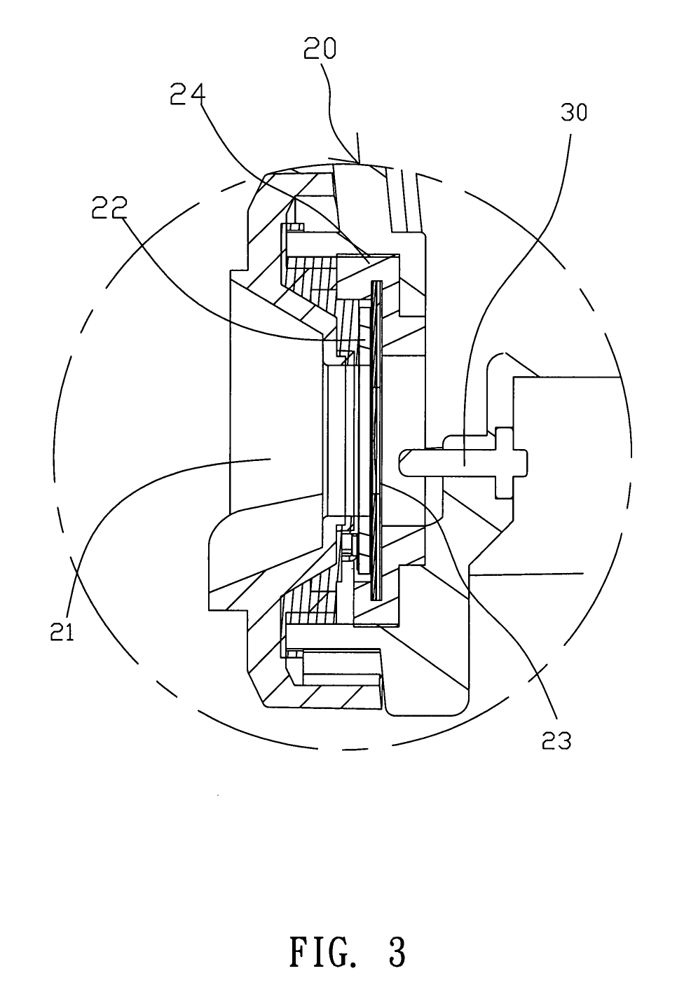

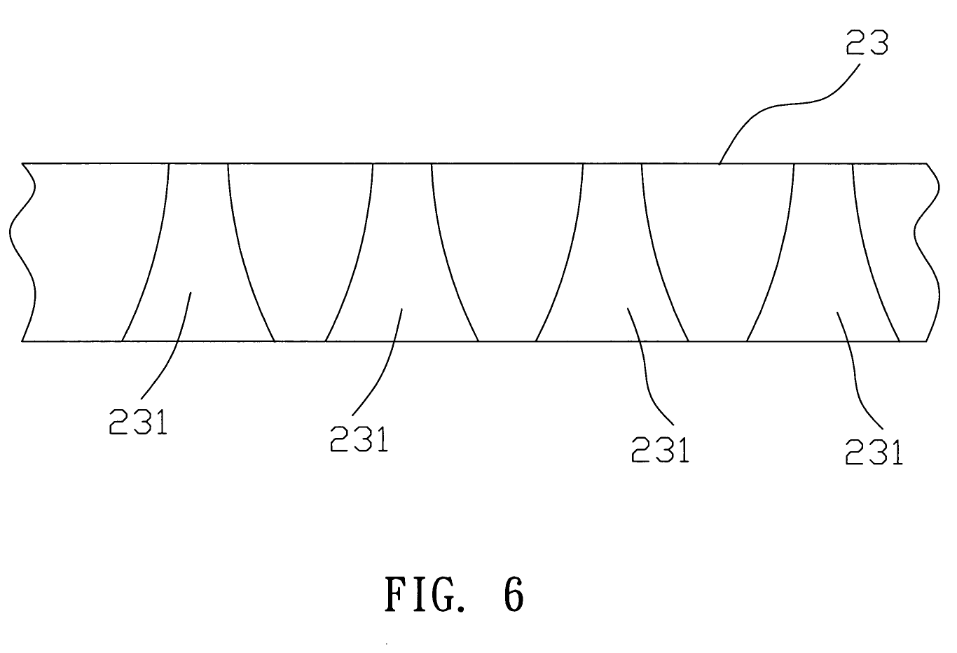

In FIGS. 2 and 3, the aerosol generator 20 is installed at a position proximate to an opening 12 at the bottom of the container 10, such that the liquid can be aerosolized and sprayed from a nozzle 21 at a protective cover of the aerosol generator 20 to the outside. The aerosol generator 20 comprises an oscillator 22 and an aperture plate 23. The oscillator 22 is a piezoelectric element controlled by a controller 40 for supplying the operating voltage to the oscillator 22 to perform vibrations or stop operating. The aperture plate 23 comprises at least one conical aperture 231 having a small diameter and tapered from the container 10 to the outside (as shown in FIG. 6), and an elastic wrapping element 24 for wrapping the oscillator 22 and the aperture plate 23. If the oscillator 22 is vibrating, the aperture plate 23 will be driven to vibrate back and forth, and the back and forth vibrations of the aperture plate 23 drives the plurality of tapered conical apertures 231 to squeeze the liquid in the container 10 to produced an aerosolization, and spray the aerosolized liquid from the nozzle 21 of the protective cover.

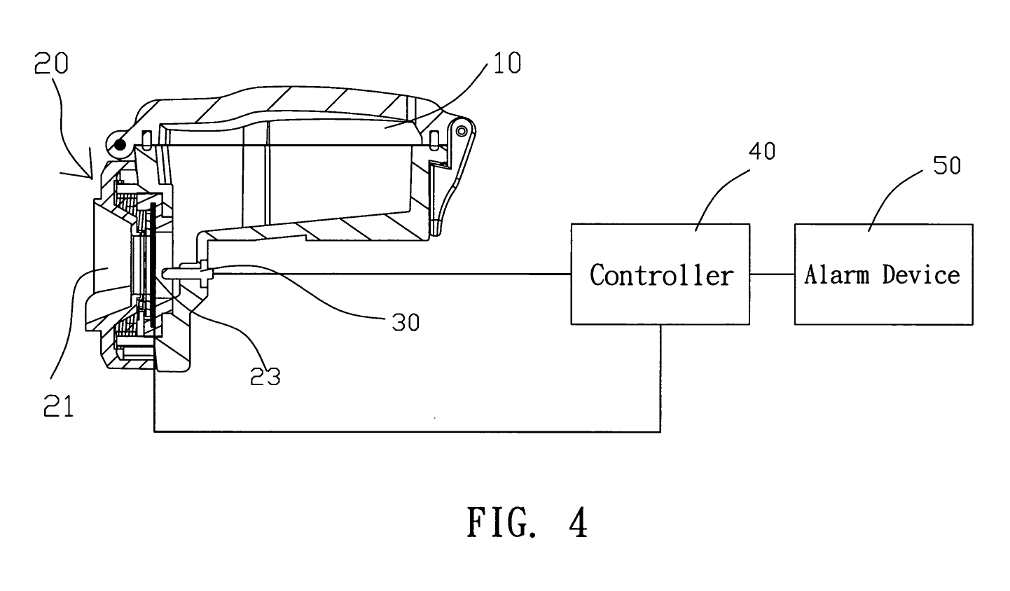

In FIG. 4, the sensor 30 comprises a piezoelectric element and a computation electric circuit. The piezoelectric element produces a corresponding variation of electric characteristic according to a condition whether or not the liquid in the container 10 is in contact with the aerosol generator 20. After the variation of the electric characteristic is measured and computed by the calculation circuit, the variation of the electric characteristic is sent to the controller 40 as a basis for controlling whether or not to continue operating the aerosol generator 20.

The electric characteristic detected by the sensor 30 includes impedance, capacitance, or inductance; and the sensor 30 could be a piezoelectric element of the aerosol generator 20 for vibration.

In another preferred embodiment, the sensor 30 is an optical sensor for detecting whether or not the liquid in the container 10 is in contact with a predetermined position of the aerosol generator 20.

In a further preferred embodiment, the sensor 30 is a conductive sensor for sensing an electric conductivity between at least two points across a surface of the liquid in the container supplied to the aerosol generator 20, and at least one of the points is situated at a position of the liquid to be supplied to the aerosol generator 20.

The conductive sensor can be fixed at a position of the liquid to be supplied to the aerosol generator 20 for detecting an electric conductivity between the conductive sensor and the aerosol generator 20.

The controller 40 can receive the value of the variation of electric characteristic detected by the sensor 30 for computation and comparison with a predetermined safe range. If the value of the detected variation exceeds the safe range, the controller 40 will immediately instruct the aerosol generator 20 to stop its operation, and simultaneously control the alarm device 50 to send out an alarm signal, such as a light or a sound.

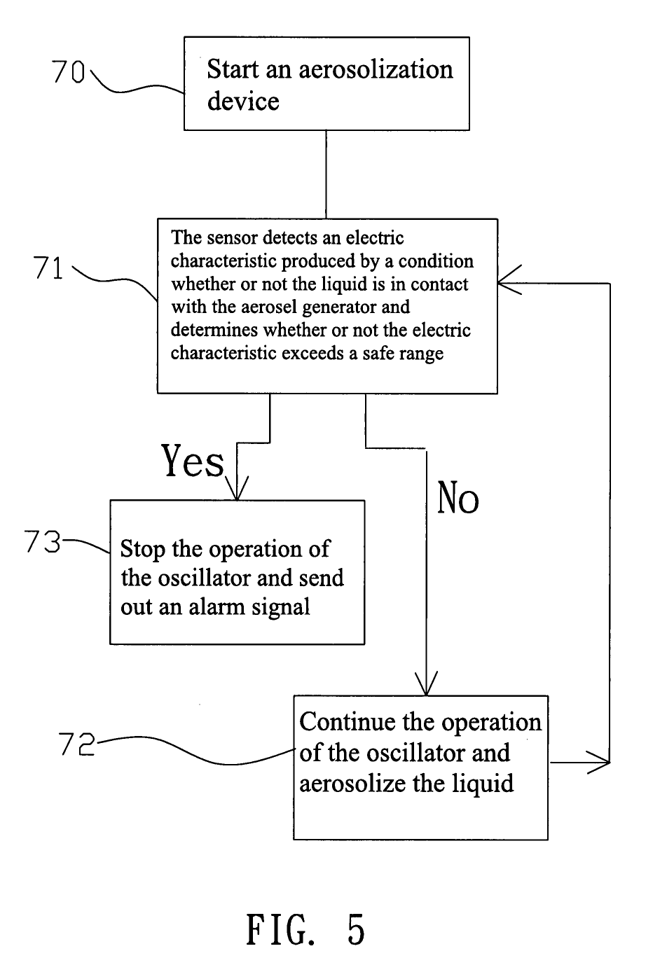

In FIG. 5, the procedure for controlling and operating the aforementioned aerosolization device comprises the following steps:

First step 70: Start an aerosolization device, and its operation will start according to a starting device pressed by a user.

Second step 71: A sensor detects an electric characteristic produced by a condition whether or not the liquid is in contact with an aerosol generator, and determines whether or not the electric characteristic exceeds a safe range; if yes, then go to the fourth step 73, or else go to the third step 72.

Third step 72: continue the operation of the oscillator and aerosolize the liquid, and then return to second step 71 to continue the detection.

Fourth step 73: If the sensor detects that the liquid exceeds the predetermined safe range, the sensor will stop the operation of the oscillator immediately, and an alarm device will send out an alarm signal.

The aerosolization device of the invention uses the sensor to monitor whether or not the liquid in the container is in contact with the aerosol generator. If the supply of the liquid is interrupted or exhausted, the controller controls the aerosol generator to stop its operation immediately, so as to assure the normal operation of the aerosolization device and steadily supply a fixed quantity of aerosol medication to patients.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An aerosolization device comprising:
a container to contain a liquid;
an aerosol generator installed at a position proximate to an opening at the bottom of said liquid container to aerosolize and spray said liquid in said container to the outside;
a sensor to detect an electric characteristic, and said electric characteristic variation according to a condition whether or not said liquid in said container is in contact with said aerosol generator; and
a controller to control to operate or stop operating said aerosol generator according to the variation of said electric characteristic detected by said sensor.

2. The aerosolization device according to claim 1, wherein said aerosol generator comprises an oscillator and an aperture plate.

3. The aerosolization device according to claim 2, wherein said aperture plate comprises a plurality of conical apertures tapered from said container to the outside.

4. The aerosolization device according to claim 2, wherein said oscillator comprises a piezoelectric element.

5. The aerosolization device according to claim 2, wherein said oscillator is provided for vibrating said aperture plate in said aerosol generator.

6. The aerosolization device according to claim 1, wherein said sensor comprises a piezoelectric element to detect whether or not said liquid in said container is in contact with said aerosol generator to generate a corresponding variation of said electric characteristic.

7. The aerosolization device according to claim 6, wherein said sensor further comprises a computation electrical circuitry for measuring a variation of impedance of said piezoelectric element.

8. The aerosolization device according to claim 1, wherein said sensor comprises an optical sensor.

9. The aerosolization device according to claim 8, wherein said optical sensor is provided for detecting whether or not said liquid in said container is in contact with a predetermined position of said aerosol generator.

10. The aerosolization device according to claim 9, wherein said predetermined position is disposed at said liquid to be supplied to said aerosol generator.

11. The aerosolization device according to claim 1, wherein said sensor comprises a conductive sensor to sense an electric conductivity between at least two points across a surface of said liquid in said container to be supplied to said aerosol generator, and at least one of said points is situated at a position of said liquid to be supplied to said aerosol generator.

12. The aerosolization device according to claim 1, wherein said electric characteristic includes impedance, capacitance, or inductance.

13. The aerosolization device according to claim 1, wherein said sensor comprises a conductive sensor disposed at a position of said liquid to be supplied to said aerosol generator to detect an electric conductivity between said conductive sensor and said aerosol generator.

14. The aerosolization device according to claim 1, wherein said controller presets a safe range for said variation of electric characteristic.

15. The aerosolization device according to claim 14, further comprising an alarm device, if said electric conductivity detected by the sensor exceeds said safe range, then said controller stops the operation of said aerosol generator, and control said alarm device to send out an alarm signal synchronously.

16. The aerosolization device according to claim 15, wherein said alarm signal comprises a light signal or a sound signal.
